(19) United States
(12) Patent Application Publication
(10) Pub. No.: US 2022/0070819 A1
(43) Pub. Date: Mar. 3, 2022

(54) Hierarchical Positioning for Low Cost and Low Power Asset Tracking

(71) Applicant: Nokia Technologies Oy, Espoo (FI)

(72) Inventors: Oana-Elena Barbu, Aalborg (DK); Johannes Harrebek, Aalborg (DK); Benny Vejlgaard, Glstrup (DK); Ryan Keating, Chicago, IL (US)

(21) Appl. No.: 17/010,070

(22) Filed: Sep. 2, 2020

(51) Int. Cl. H04W 64/00; H04L 25/02; H04L 5/00; H04W 72/12

(52) U.S. Cl. CPC H04W 64/006; H04L 25/0226; H04W 72/1257; H04W 72/121; H04L 5/0051

(57) ABSTRACT

A TRP clusters multiple UEs into a group, configures selected ones of the UEs in the group to be head UEs, and configures UEs not selected as head UEs to be group UEs. The group UEs are configured to send signals or calculated information used for positioning of the group UEs to head UEs instead of to the TRP. The TRP receives calculated information that was calculated by the head UEs from the signals or calculated information used for positioning of the group UEs, and forwards the calculated information from the head user equipment toward a network node for position determination of the group UEs. The head UEs both transmit to and receive signals from the group UEs and use the signals to calculate the calculated information. The head UEs may also receive information calculated by the group UEs, which is also used to calculate the calculated information.

### TECHNICAL FIELD

Exemplary embodiments herein relate generally to wireless communications and, more specifically, relate to asset tracking using wireless communications.

### BACKGROUND

Many companies use asset tracking to determine locations of their assets. Asset tracking has wide applicability, such as providing tracking of products in a warehouse, tracking of vehicles or electronics owned by a company, and the like. Asset tracking also allows knowing the location, status, maintenance schedule, and other important information about an organization's physical assets.

Asset tracking tags provide ubiquitous localization of assets without requiring massive scale ecosystem deployment. Outdoors, tags may be localized through a public cellular network, providing global coverage and 10-20 meter accuracy with no dedicated equipment in some use cases. Once in an indoor environment, these tags may be located using densely deployed infrastructure locators and flexible asset tracking gateways offering accuracy of within 1-2 meters in some use cases. Furthermore, the tags may provide an IR (infrared) beacon feature that allows infrastructure camera-based algorithms to enhance localization.

For densely populated assets, positioning can be problematic. Even if the amount of data for positioning is relatively “small”, when there are tens, hundreds, or even thousands of assets, trying to determine positioning based on all of that data may be problematic.

### BRIEF SUMMARY

This section is intended to include examples and is not intended to be limiting.

In an exemplary embodiment, a method is disclosed that includes clustering by a transmission-reception point multiple user equipment into a group of user equipment, and configuring by the transmission-reception point selected ones of the user equipment in the group to be head user equipment. The method includes configuring by the transmission-reception point user equipment not selected as head user equipment to be group user equipment. The group user equipment are configured to send signals or calculated information used for positioning of the group user equipment to head user equipment instead of to the transmission-reception point. The method also includes receiving, at the transmission-reception point and from the head user equipment, calculated information that was calculated by the head user equipment from the signals or calculated information used for positioning of the group user equipment. The method includes forwarding by the transmission-reception point the calculated information from the head user equipment toward a network node for position determination of the group user equipment.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: clustering by a transmission-reception point multiple user equipment into a group of user equipment; configuring by the transmission-reception point selected ones of the user equipment in the group to be head user equipment; configuring by the transmission-reception point user equipment not selected as head user equipment to be group user equipment, wherein the group user equipment are configured to send signals or calculated information used for positioning of the group user equipment to head user equipment instead of to the transmission-reception point; receiving, at the transmission-reception point and from the head user equipment, calculated information that was calculated by the head user equipment from the signals or calculated information used for positioning of the group user equipment; and forwarding by the transmission-reception point the calculated information from the head user equipment toward a network node for position determination of the group user equipment.

An exemplary computer program product includes a computer-readable storage medium bearing computer program code embodied therein for use with a computer. The computer program code includes: code for clustering by a transmission-reception point multiple user equipment into a group of user equipment; code for configuring by the transmission-reception point selected ones of the user equipment in the group to be head user equipment, code for configuring by the transmission-reception point user equipment not selected as head user equipment to be group user equipment, wherein the group user equipment are configured to send signals or calculated information used for positioning of the group user equipment to head user equipment instead of to the transmission-reception point; code for receiving, at the transmission-reception point and from the head user equipment, calculated information that was calculated by the head user equipment from the signals or calculated information used for positioning of the group user equipment; and code for forwarding by the transmission-reception point the calculated information from the head user equipment toward a network node for position determination of the group user equipment.

In another exemplary embodiment, an apparatus comprises means for performing: clustering by a transmission-reception point multiple user equipment into a group of user equipment; configuring by the transmission-reception point selected ones of the user equipment in the group to be head user equipment, configuring by the transmission-reception point user equipment not selected as head user equipment to be group user equipment, wherein the group user equipment are configured to send signals or calculated information used for positioning of the group user equipment to head user equipment instead of to the transmission-reception point; receiving, at the transmission-reception point and from the head user equipment, calculated information that was calculated by the head user equipment from the signals or calculated information used for positioning of the group user equipment; and forwarding by the transmission-reception point the calculated information from the head user equipment toward a network node for position determination of the group user equipment.

In an exemplary embodiment, a method is disclosed that includes receiving, at a user equipment and from a transmission-reception point, configuration indicating the user equipment is to be a head user equipment, indicating that group user equipment are to send signals used for positioning of the group user equipment to corresponding head user equipment. The method also includes transmitting by the head user equipment first sounding reference signals toward the transmission-reception point and the group user equipment, and receiving, by the head user equipment and from one of the group user equipment, second sounding reference signals for positioning of the one group user equipment. The method further includes calculating by the head user equipment information for positioning of the one group user equipment, the calculating based at least on the sending the first sounding reference signals and the receiving the sounding reference signals. The method includes sending by the head user equipment the calculated information toward the transmission-reception point for forwarding to a network node for position determination of the group user equipment.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: receiving, at a user equipment and from a transmission-reception point, configuration indicating the user equipment is to be a head user equipment, indicating that group user equipment are to send signals used for positioning of the group user equipment to corresponding head user equipment; transmitting by the head user equipment first sounding reference signals toward the transmission-reception point and the group user equipment; receiving, by the head user equipment and from one of the group user equipment, second sounding reference signals for positioning of the one group user equipment; calculating by the head user equipment information for positioning of the one group user equipment, the calculating based at least on the sending the first sounding reference signals and the receiving the sounding reference signals; and sending by the head user equipment the calculated information toward the transmission-reception point for forwarding to a network node for position determination of the group user equipment.

An exemplary computer program product includes a computer-readable storage medium bearing computer program code embodied therein for use with a computer. The computer program code includes: code for receiving, at a user equipment and from a transmission-reception point, configuration indicating the user equipment is to be a head user equipment, indicating that group user equipment are to send signals used for positioning of the group user equipment to corresponding head user equipment; code for transmitting by the head user equipment first sounding reference signals toward the transmission-reception point and the group user equipment; code for receiving, by the head user equipment and from one of the group user equipment, second sounding reference signals for positioning of the one group user equipment; code for calculating by the head user equipment information for positioning of the one group user equipment, the calculating based at least on the sending the first sounding reference signals and the receiving the sounding reference signals; and code for sending by the head user equipment the calculated information toward the transmission-reception point for forwarding to a network node for position determination of the group user equipment.

In another exemplary embodiment, an apparatus comprises means for performing: receiving, at a user equipment and from a transmission-reception point, configuration indicating the user equipment is to be a head user equipment, indicating that group user equipment are to send signals used for positioning of the group user equipment to corresponding head user equipment; transmitting by the head user equipment first sounding reference signals toward the transmission-reception point and the group user equipment; receiving, by the head user equipment and from one of the group user equipment, second sounding reference signals for positioning of the one group user equipment; calculating by the head user equipment information for positioning of the one group user equipment, the calculating based at least on the sending the first sounding reference signals and the receiving the sounding reference signals; and sending by the head user equipment the calculated information toward the transmission-reception point for forwarding to a network node for position determination of the group user equipment.

In an exemplary embodiment, a method is disclosed that includes receiving, at a user equipment and from a transmission-reception point, configuration indicating the user equipment is to be a group user equipment, the configuration indicating that the group user equipment is to transmit signals for positioning of the group user equipment to corresponding head user equipment instead of to the transmission-reception point; and transmitting, by the group user equipment and to the head user equipment, signals for positioning of the group user equipment.

An additional exemplary embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer. Another example is the computer program according to this paragraph, wherein the program is directly loadable into an internal memory of the computer.

An exemplary apparatus includes one or more processors and one or more memories including computer program code. The one or more memories and the computer program code are configured to, with the one or more processors, cause the apparatus to perform operations comprising: receiving, at a user equipment and from a transmission-reception point, configuration indicating the user equipment is to be a group user equipment, the config indicating that the group user equipment is to transmit signals for positioning of the group user equipment to corresponding head user equipment instead of to the transmission-reception point; and transmitting, by the group user equipment and to the head user equipment, signals for positioning of the group user equipment.

An exemplary computer program product includes a computer-readable storage medium bearing computer program code embodied therein for use with a computer. The computer program code includes: code for receiving, at a user equipment and from a transmission-reception point, configuration indicating the user equipment is to be a group user equipment, the config indicating that the group user equipment is to transmit signals for positioning of the group user equipment to corresponding head user equipment instead of to the transmission-reception point; and code for transmitting, by the group user equipment and to the head user equipment, signals for positioning of the group user equipment.

In another exemplary embodiment, an apparatus comprises means for performing: receiving, at a user equipment and from a transmission-reception point, configuration indicating the user equipment is to be a group user equipment, the config indicating that the group user equipment is to transmit signals for positioning of the group user equipment to corresponding head user equipment instead of to the transmission-reception point; and transmitting, by the group user equipment and to the head user equipment, signals for positioning of the group user equipment.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 illustrates an asset tracking scenario;

FIG. 3 illustrates an overview of an UL-TDOA technique;

FIG. 4 illustrates interplay between features and technology used to implement those features in NR Lite in Rel. 17;

FIG. 5A, split over FIGS. 5A-1 and 5A-2, is a flowchart of a method for hierarchical positioning of UEs in accordance with an exemplary embodiment;

FIG. 5B illustrates grouping of UEs by a serving gNB following the method in FIG. 5A; and

FIG. 6 is a signaling diagram illustrating a two-step positioning method, in accordance with an exemplary embodiment.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for hierarchical positioning for low cost and low power asset tracking. Additional description of these techniques is presented after a system into which the exemplary embodiments may be used is described.

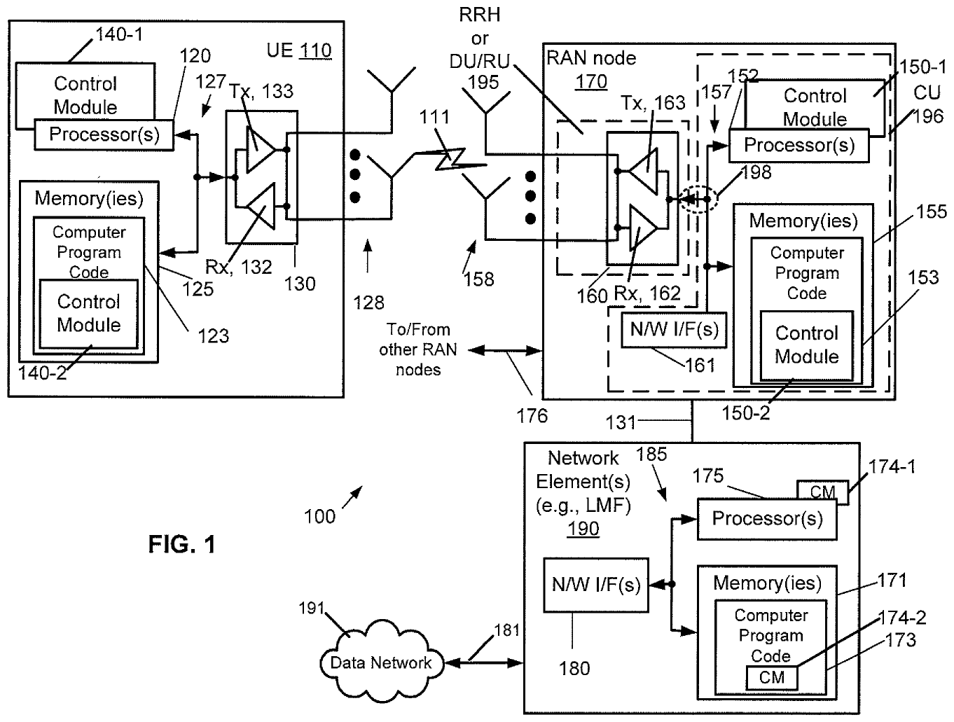

Turning to FIG. 1, this figure shows a block diagram of one possible and non-limiting exemplary system in which the exemplary embodiments may be practiced. A user equipment (UE) 110, radio access network (RAN) node 170, and network element(s) 190 are illustrated. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a control module 140, comprising one of or both parts 140-1 and/or 140-2, which may be implemented in a number of ways. The control module 140 may be implemented in hardware as control module 140-1, such as being implemented as part of the one or more processors 120. The control module 140-1 may be implemented also as an integrated circuit or through other hardware such as a programmable gate array. In another example, the control module 140 may be implemented as control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 is a base station that provides access by wireless devices such as the UE 110 to the wireless network 100. The RAN node 170 may be, for instance, a base station for 5G, also called New Radio (NR). This is referred to usually as a gNB, and the RAN nodes 170 herein will also be referred to as gNBs. In 5G, the RAN node 170 may be a NG-RAN node, which is defined as either a gNB or an ng-eNB. A gNB is a node providing NR user plane and control plane protocol terminations towards the UE, and connected via the NG interface to a 5GC (e.g., the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g., as part of an RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a control module 150, comprising one of or both parts 150-1 and/or 150-2, which may be implemented in a number of ways. The control module 150 may be implemented in hardware as control module 150-1, such as being implemented as part of the one or more processors 152. The control module 150-1 may be implemented also as an integrated circuit or through other hardware such as a programmable gate array. In another example, the control module 150 may be implemented as control module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the control module 150 may be distributed, such as being distributed between the DU 195 and the CU 196, or be implemented solely in the DU 195.

The one or more network interfaces 161 communicate over a network such as via the links 176 and 131. Two or more RAN nodes 170 communicate using, e.g., link 176. The link 176 may be wired or wireless or both and may implement, e.g., an Xn interface for 50, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, e.g., fiber optic cable or other suitable network connection to connect the other elements (e.g., a central unit (CU), gNB-CU) of the RAN node 170 to the RRH/DU 195. Reference 198 also indicates those suitable network link(s).

It is noted that the RAN nodes 170, including their various forms such as gNB, eNB, CU, DU, or the like, may be generalized as transmission-reception points (TRPs). That is, a TRP could be a base station, a gNB, a RAN node with a CU, where the DU is remotely located, a DU, a RRH, or the like.

The wireless network 100 may include a network element or elements 190 that may include core network functionality, and which provides connectivity via a link or links 181 with a data network 191, such as a telephone network and/or a data communications network (e.g., the Internet). The network element 190 may be an LMF. Such core network functionality for 5G may also include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely exemplary functions that may be supported by the network element(s) 190, and note that both 5G and LTE functions might be supported. The RAN node 170 is coupled via a link 131 to a network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The control module (CM) 174 may be circuitry, such as part of the one or more processors 175 (as CN 174-1), or may be software (as CM 174-2), or both. The one or more memories 171 and the computer program code 173 are configured to, with the one or more processors 175, cause the network element 190 to perform one or more operations, e.g., under control of the CM 174.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, vehicles with a modem device for wireless V2X (vehicle-to-everything) communication, image capture devices such as digital cameras having wireless communication capabilities, gaming devices having wireless communication capabilities, music storage and playback appliances having wireless communication capabilities, Internet appliances (including Internet of Things, IoT, devices) permitting wireless Internet access and possibly browsing, IoT devices with sensors and/or actuators for automation applications with wireless communication tablets with wireless communication capabilities, as well as portable units or terminals that incorporate combinations of such functions.

Having thus introduced one suitable but non-limiting technical context for the practice of the exemplary embodiments, the exemplary embodiments will now be described with greater specificity.

As described above, asset tracking tags provide ubiquitous localization of assets without requiring massive scale ecosystem deployment. In order to allow tracking of handling and storage conditions, asset tracking tags maintain vectors such as motion vectors, ambience vectors and co-presence vector using, e.g., onboard accelerometer, temperature and humidity sensors. These vectors are offloaded periodically to the asset tracking gateways in an energy-efficient way.

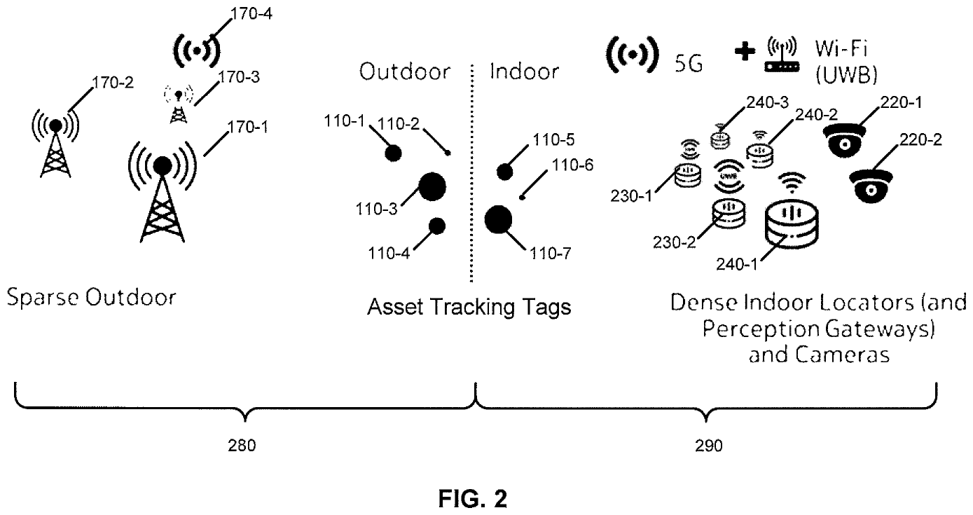

Turning to FIG. 2, this figure illustrates an asset tracking scenario. An outdoor scenario 280 and an indoor scenario 290 are illustrated. In this example, there are multiple Transmission Reception Points (TRPS) 170-1, 170-2, 170-3, and 170-4 in the outdoor scenario 280. There are also indoor locators 240-1, 240-2, and 240-3, which are densely populated, and asset tracking gateways 230-1, 230-2. The TRPs may be, e.g., may be gNBs, IAB nodes, and the like. There are outdoor asset tracking tags, represented as 110-1, 110-2, 110-3, and 110-4, and also indoor asset tracking tags, represented as 110-5, 110-6, and 110-7. The size of the dot used to represent the asset tracking tag is used to designate the various sizes of the assets that they track.

With respect to positioning, a Rel-16 work item was conducted in 3GPP for native positioning support in New Radio (NR). See RP-190752, Intel Corporation, Ericsson, “New WID: NR Positioning Support”, 3GPP TSG RAN Meeting #83, Shenzhen, China, Mar. 18-21, 2019. As the result of that work, the following positioning solutions are specified for NR Rel-16 (note that RAN1 has completed its work while RAN2/3 are finalizing the signaling details):

Downlink Time Difference of Arrival (DL-TDOA);

Uplink Time Difference of Arrival (UL-TDOA);

Downlink Angle of Departure (DL-AoD);

Uplink Angle of Arrival (UL-AoA); and

Multi-cell Round Trip Time (Multi-RTT).

The work is to specify solutions to enable RAT dependent (for both FR1 and FR2) and RAT independent NR positioning techniques. In the DL a new positioning reference signal (PRS) was introduced and in the UL a new SRS for positioning (SRS-P) was introduced. See R1-1913661, “Positioning CR to TS 38.211”, 3GPP TSG-RAN WG1 Meeting #99, Reno, Nev., USA, Nov. 18-22, 2019.

In release 17, there will be further work on NR positioning with the following main target, see the following (see RP-193237, Qualcomm Incorporated, “New SID for Positioning Enhancements”, 3GPP TSG RAN Meeting #86, Sitges, Spain, Dec. 9-12, 2019): “Study enhancements and solutions necessary to support the high accuracy (horizontal and vertical), low latency, network efficiency (scalability, RS overhead, etc.), and device efficiency (power consumption, complexity, etc.) requirements for commercial uses cases (incl. general commercial use cases and specifically (I)IoT use cases”.

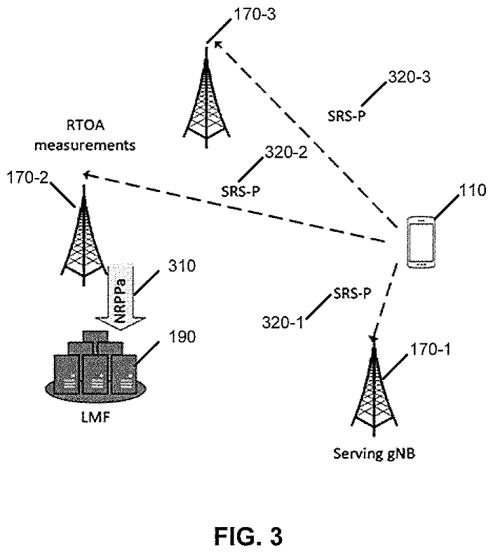

UL-TDOA is one of the Rel-16 methods specified and relies on UL measurements/signals. At a high level, the method works by UEs transmitting the SRS-P to the gNBs. The gNBs measure the Relative Time of Arrival (RTOA) based on the SRS-P from the UE. All the measurements are reported to the location management function (LMF) which can then estimate the position of the UE. The gNB report measurements over the New Radio Positioning Protocol A (NRPPa). FIG. 3 shows an overview of the technique.

FIG. 3 illustrates an overview of an UL-TDOA technique, and the serving gNB 170-1 and other gNBs 170-2 and 170-3 are shown. The UE 110 transmits SRS signals SRS-P 320-1, 320-2, and 320-3 and these signals are received by the corresponding gNBs 170-1, 170-2, and 170-3. The gNB 170-2 performs RTOA measurements and sends the results of this via NRPPa 310 to the LMF 190.

Another area in which this is used is NR Lite. NR-LITE should address new use cases with IoT-type of requirements (e.g. low-complexity, enhanced coverage, long battery life, and massive number of devices) that cannot be met by eMTC and NB-IoT. NR Lite is subject to standardization as part of Rel-17, which is just about to start in 3GPP.

Requirements and use cases include the following:

1) Data rates up to [10-100] Mbps to support e.g. live video feed, visual production control, process automation.

2) Latency of around [10-30] ms to support e.g. remote drone operation, cooperative farm machinery, time-critical sensing and feedback, remote vehicle operation.

3) Positioning accuracy of [30 cm-1 m] to support e.g. indoor asset tracking, coordinated vehicle control, remote monitoring.

4) Module cost comparable to LTE.

5) Coverage enhancement of [10-15] dB compared to eMBB.

6) Battery life [2-4×, where X=times] longer than eMBB.

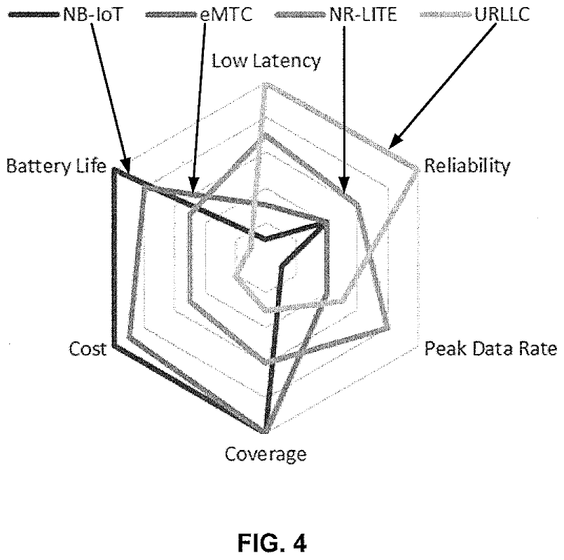

FIG. 4 illustrates interplay between features and technology used to implement those features in NR Lite in Rel. 17. The features illustrated are low latency, reliability, peak data rate, coverage, cost and battery life. The technologies are NB-IoT, eMTC, NR-LITE, and URLLC. As an example, URLLC has low latency and reliability, but is higher in cost. NB-IoT, meanwhile, is lower in cost, but lacks low latency and reliability.

The targeted NR Lite features include the following:

1) Reduced bandwidth operation;

2) Complexity reduction techniques;

3) Coverage and reliability enhancements;

4) D2D communication;

5) Early data transmission;

6) Wake-up signal in idle mode; and/or

7) Grant-free transmission.

Low cost assets tracking for Rel. 17 is key focus area, for the reasons described above. The Rel. 17 scope include the accurate positioning as outlined in the above as well as the reduced complexity device (e.g., NR Lite) also described above.

One exemplary scenario is the following. A main target for assets tracking is to accurately provide the location of low cost and low power tags. A global working solution is desirable that covers diverse scenarios ranging from remote rural areas, urban outdoor areas, and indoor areas (including homes, offices, and larger factories). The requirements for assets tracking positioning accuracy are assumed to vary; e.g., have less strict accuracy for items that are in commute on highways or at sea, while items in denser areas such as, e.g., factories and storage/delivery facilities calls for higher positioning accuracy.

One of the key elements in accurate positioning is to either receive or transmit a wideband signal (e.g., 100 MHz or more dependent on the accuracy target) for downlink or uplink-based positioning. Both downlink and uplink-based positioning will require a wideband device, which is both costly and power consuming. The KPIs for IoT devices such as asset tags are cost and power consumption. The wide bandwidth requirement is conflicting with NR Light, for which one of the objectives is to reduce the bandwidth to reduce cost. The current target for NR Light is to reduce bandwidth to 5 or 20 MHz, discussion to be agreed in 3GPP Rel. 17 SI. It will not be possible to support e.g. 100 MHz or more as required for the positioning. A further complexity is the cost of NR Lite.

The target for the NR Lite cost reduction is a modem in the cost range of LTE, which is still significantly too much compared to low cost assets tracking, where the cost position should be in the sub USD (United States Dollar) range. This is in apparent conflict with accuracy for positioning.

One issue therefore is to provide device (e.g., asset tag) accuracy, such as for 5G NR (Rel. 17) positioning with ultra-low-cost devices.

An overview is provided now, and more details are provided below. In this document, methods and associated signaling are described that enable the network to compute the positions of all UEs (the assets to be tracked) in a group without explicit UL signaling from all UEs in the group. The benefit of such an exemplary approach is the reduction in power consumption for the majority of UEs in the group, as only a small set of UEs will communicate with the network, and therefore perform high power SRS transmissions.

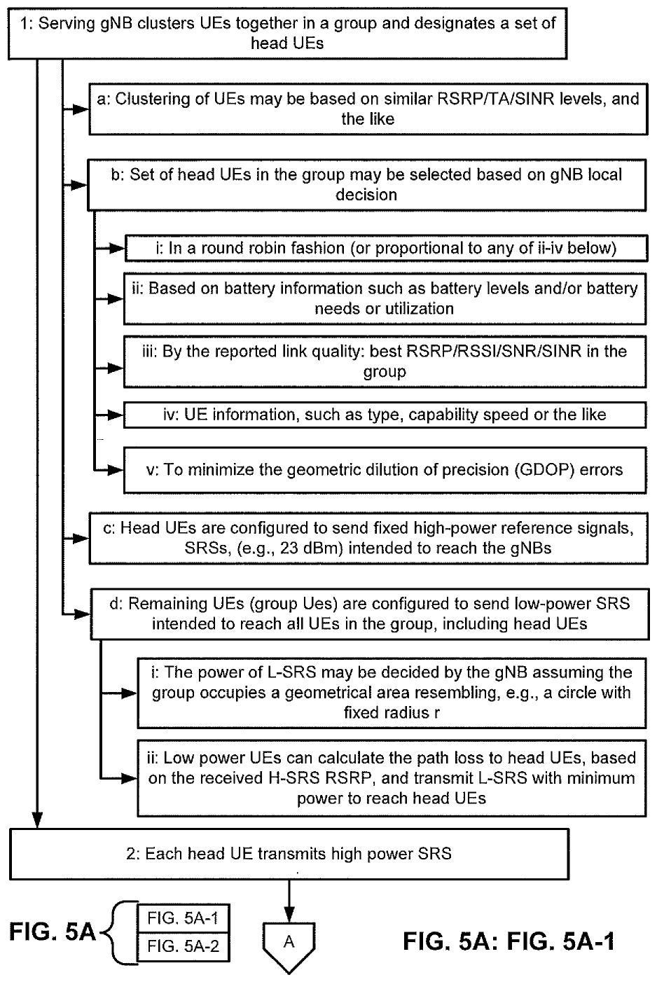

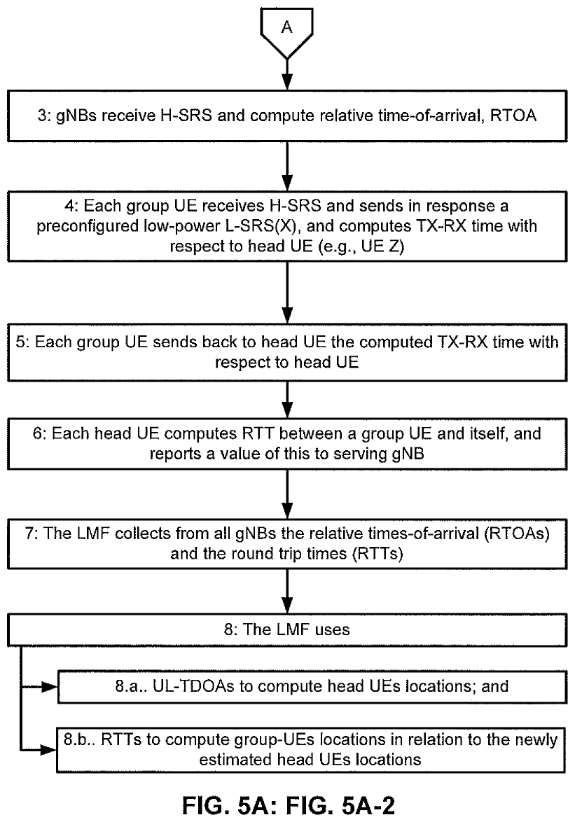

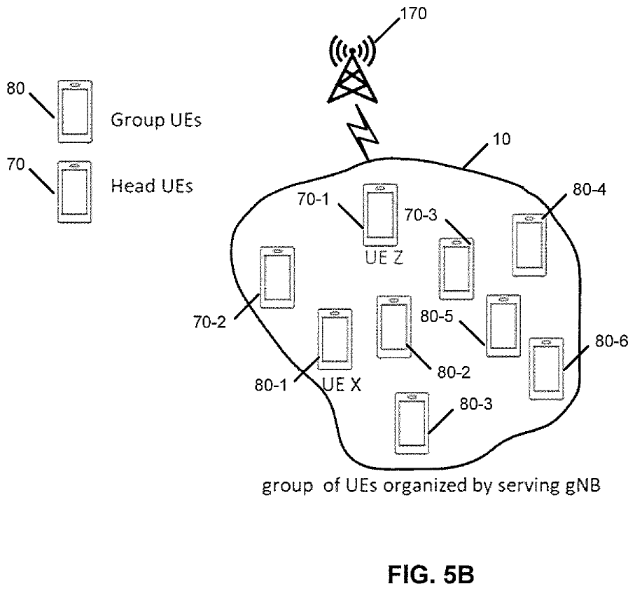

An exemplary embodiment includes the following signaling and processing blocks (see FIGS. 5A and 5B also). FIG. 5A, split over FIGS. 5A-1 and 5A-2, is a flowchart of a method for hierarchical positioning of UEs in accordance with an exemplary embodiment. This figure further illustrates the operation of an exemplary method or methods, a result of execution of computer program instructions embodied on a computer readable memory, functions performed by logic implemented in hardware, and/or interconnected means for performing functions in accordance with exemplary embodiments. The blocks may be performed by a UE 110, gNB 170, or LMF 190, as appropriate, e.g., under control of their respective control modules 140, 150, 174.

Although FIG. 5B is described in more detail below, a brief introduction is presented now. UEs 70 and 80 are illustrated. There are head UEs 70 and group UEs 80. Head UEs 70-1, 70-2 and 70-3 are shown, and group UEs 8001, 80-2, 80-3, 80-4 and 80-5 are shown. These head and group UEs are both part of the group 10 of UEs, which can communicate to the gNB 170.

Turning to FIG. 5A (see also FIG. 5B) a serving gNB 170 clusters (see step 1.) UEs 110 together in a group 10 and designates a set of head UEs 70 (e.g., at least three):

1.a. The clustering of UEs may be based on similar RSRP/TA/SINR levels, and the like.

1.b. The set of head UEs in the group may be selected based on gNB local decision, e.g. one or more of the following:

i. In a round robin fashion, e.g., for battery saving purposes (e.g., or proportional to any of ii to iv below).

ii. Based on batter information such as the battery levels and/or battery needs or utilization (e.g. battery-less devices may be prioritized).

iii. By the reported link quality: best RSRP/RSSI/SNR/SINR in the group.

iv. By UE information, such as type (e.g., if some UEs are “regular” NR UEs while others are NR-lite UEs), capability (e.g., type of processor or processor speed or both), speed (i.e., velocity), or the like.

v. To minimize the geometric dilution of precision (GDOP) errors (in the case that coarse location of some UEs is known already/coarsely estimated based on past locations and a mobility model, dead-reckoning, or the like).

1.c. Head UEs 70 are configured to send fixed high-power reference signals, SRSs, (e.g., 23 dBm) intended to reach the gNBs (and consequently, their SRSs are heard by all UEs in the group). We refer to these SRS as H-SRS. High power may be full power, i.e., maximum allowed transmit power, or within a small percentage of this, such as five to 10 percent.

1.d. Remaining UEs (group UEs 80, remaining in the group 10 after the head UEs 70 are selected) are configured to send low-power SRS intended to reach all UEs in the group, including head UEs 70. We refer to these SRS as L-SRS. Low power in this context is a lower power than that of H-SRS. This may be configured as a fraction of the maximum allowed power, so that L-SRS reaches a UE no farther than a predetermined distance, e.g., much lower than the distance to the serving gNB.

These UEs will send L-SRS in response to receiving H-SRS. See the following.

i. The power of L-SRS may be decided by the gNB assuming the group occupies a geometrical area resembling, e.g., a circle with fixed radius r. The gNB assumes a certain pathloss model and configures the power so that any group-edge UE can be heard by any other (diametrically opposite) group-edge UE.

ii. Alternatively, low power UEs can calculate the path loss to head UEs, based on the received H-SRS RSRP, and transmit L-SRS with minimum power to reach head UEs (assuming omnidirectional transmission).

2. Each head UE, say UE-Z 70-1, transmits high power SRS: H-SRS(Z).

3. gNBs receive H-SRS(Z) and compute, based at least on the received H-SRS-(Z), relative time-of-arrival RTOA(Z). This uses the example of UE-Z.

4. Each group UE 80, say UE X 80-1, receives H-SRS(Z) and sends in response a preconfigured low-power L-SRS(X), and also computes TX-RX time with respect to head UE Z, called D(X,Z). In an exemplary embodiment, this is the difference between the transmit time of the L-SRS(X) and the reception of the H-SRS(Z), which is the time it takes the UE X from reception of H-SRS(Z) to transmission of L-SRS(X).

5. Each group UE sends back to head UE-Z the quantity D(X,Z).

6. Each head UE-Z computes RTT(X, Z) (RTT between the head UE and a group UE) and reports this value to the serving gNB: RTT(X,Z). The RTT(X,Z) may be calculated as a difference between a transmit time of H-SRS(Z) and a reception time of L-SRS(X), e.g., after subtracting the D(X,Z). It is noted that the RTT(X,Z) may be calculated without subtracting the D(X,Z), although using the D(X,Z) should improve location accuracy.

7. LMF 190 collects from all gNBs 170: RTOA(Z), RTT(X, Z).

8. The LMF 190 uses:

a. UL-TDOAs to compute head UEs locations; and

b. RTTs to compute group UEs locations in relation to the newly estimated head UEs locations from step 8.a.

Now that an overview has been provided, additional details are provided. In an exemplary embodiment, a two-step method is proposed for obtaining the positions of all UEs in a group, by clustering the UEs into the following clusters.

1) Head UEs 70. This cluster of UEs is in charge of communicating with the gNBs and transmitting high power SRS signals, H-SRS.

2) Group UEs 80. This cluster of UEs is not in the head cluster, and the group UEs communicate only with the head UEs. The UEs in this cluster transmit low power SRS, L-SRS, intended for the head UEs, and in response to receiving H-SRS.

Following the grouping and hierarchization (e.g., the group UEs communicate with the head UEs, which communicate with the gNBs), the LMF 190 computes the positions of the head UEs, after collecting RTOA measurements from all the gNBs 170 detecting H-SRS. Subsequently, the LMF 190 collects from the head UEs the RTT measured between the head UEs 70 and the group UEs 80. With this information, the LMF 190 may compute the location of the group UEs 80 with respect to the head UEs 70 (whose position has just been obtained). In this way, the head UEs 70 act as artificial TRPs for the group UEs 80.

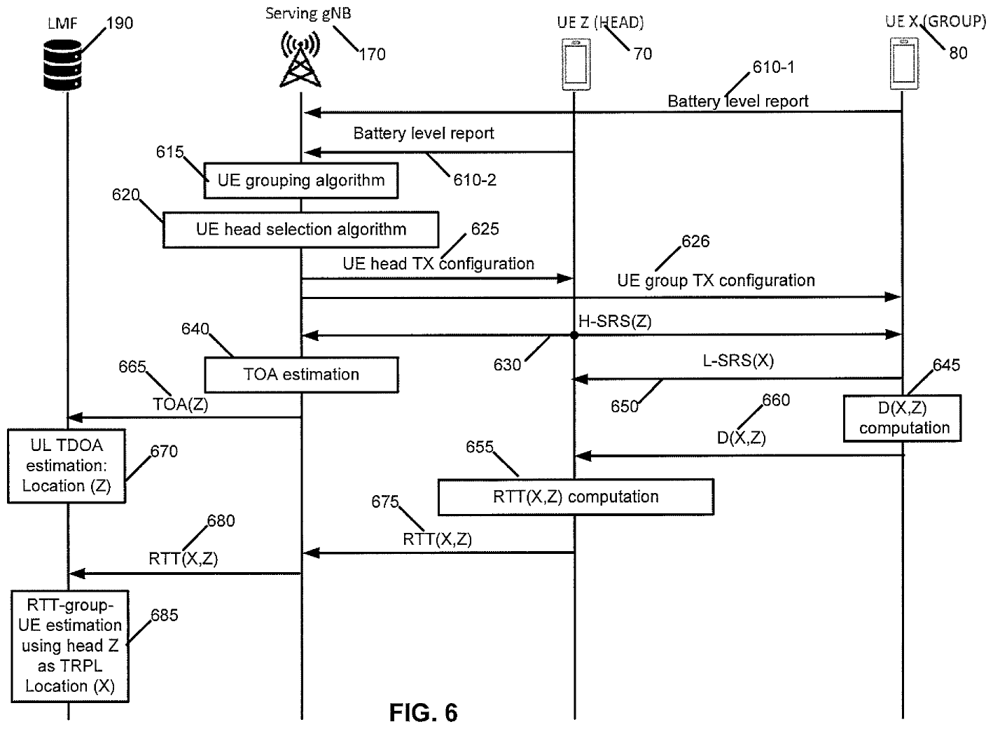

An exemplary information exchange is depicted in FIG. 6. This figure further illustrates the operation of an exemplary method or methods, a result of execution of computer program instructions embodied on a computer readable memory, functions performed by logic implemented in hardware, and/or interconnected means for performing functions in accordance with exemplary embodiments. The blocks may be performed by a UE 110 (in this case, UEs 70/80), gNB 170, or LMF 190, as appropriate, e.g., under control of their respective control modules 140, 150, 174. FIG. 6 includes the following exemplary elements. Reference may also be made to FIGS. 5A and 5B.

In signaling 610-1 and 610-2, UEs 70 and 80 send their battery capabilities to the serving gNB 170. This may be represented as one or more of the following:

a. A flag for indicating the UE is on (or not on) battery-power or whether the UE is a battery-less device;

b. A battery level (e.g., percentage or discreet level:=0/1/2) and/or consumption rate (mW/h or as discreet level=fast/slow).

The serving gNB 170 clusters UEs into a group 10. The gNB may decide to cluster the UEs according to their experienced channel conditions, e.g., similar RSRP levels, similar TA, same serving beam index, and the like. This is illustrated by block 615, where the serving gNB performs a UE grouping algorithm. See also steps 1 and 1.a. of FIG. 5A.

The serving gNB 170 decides on a group of head UEs: within the overall group 10 (all the UEs), the serving gNB 170 selects a set of K>2 UEs to act as artificial TRPs for the group UEs and maintain the communication to the gNBs. This is illustrated by the UE head selection algorithm in block 620. See also steps 1 and 1.b. in FIG. 5A. It is noted that the set of K>2 UEs ensures that an unambiguous location can be estimated. Otherwise, the system of equation is underdetermined.

Head UEs 70 may be selected based on any one or more of the following:

a. Battery capabilities, i.e. whether they are battery-less devices, and otherwise have high battery level and/or slow battery consumption rate (see also step b.ii of FIG. 5A);

b. UE type, i.e. NR or NR-lite (see also step b.iv of FIG. 5A);

c. UE speed (i.e., velocity) (see also step b.iv of FIG. 5A);

d. RSRP levels, or any other link quality metric (see also step b.iii of FIG. 5A);

e. Round robin (see also step b.i of FIG. 5A) or proportional to any combination of a-c. Regarding the proportionality, this could be similar to proportional fair scheduling, e.g., this might be used by computing a weighted average of any of the above quantities.

Note that additional examples were also presented above.

After blocks 615 and 620, the gNB 170 sends configuration messages to the head UEs 70 and to the group UEs 80 (e.g., the other UEs in the group 10 that are not head UEs 70). This is illustrated by the UE head TX configuration message 625 (see also step 1.c of FIG. 5A), and by the UE group TX configuration message 626 (see also step 1.d of FIG. 5A). The configuration message may contain:

a. Unique head sequence ID and power levels for H-SRS. This is for message 625.

b. Unique group sequence ID, time/frequency resources and power levels for L-SRS. This is for message 626.

It should be noted that the comb-structure of SRS can be used to multiplex L-SRS from multiple UEs during the same symbols to avoid interference issues.

Signaling 630 indicates the head UEs 70 transmit H-SRS, and the gNBs 170 and group UEs 80 receive them.

The reception of the H-SRS triggers the transmission of L-SRS by the group UEs 70. See signaling 650, which for UE X is represented as L-SRS(X) (see also step 4 of FIG. 5A). The transmit power level may be selected based on path loss calculation to the head UE, so that the L-SRS is received by the head UE 70, but the signal not expected to travel further than that.

Each group UE 80 computes and sends back to head the transmit-receive time difference D. This computation is shown occurring after the transmission of L-SRS. The computation occurs in block 645 and is illustrated for a head UE Z and a group UE X as D(X,Z) computation. See also step 4 of FIG. 5A. The sending of the computed D(X,Z) is illustrated as a message in signaling 660. Calculation of the transmit-receive time difference is known, but can be determined in an exemplary embodiment as the following: D(X,Z)=(time L-SRS was sent)−(time H-SRS was received). That is, D(X,Z) can be considered to be the processing time on the group UE X.

The serving gNB 170 performs a TOA estimation in block 640. This has been previously illustrated as an RTOA computation in step 3 of FIG. 5A.

The calculations for RTT are well known, but can be in an exemplary embodiment the following: RTT(X,Z)=(time L-SRS was received)−(time H-SRS was sent)−D(X,Z). See also block 655.

The head UEs 70 collect the information from all UEs in the group and forward this information to the LMF 190. See signaling 675 (see also step 6 of FIG. 5A) and signaling 680 (see also step 7 of FIG. 5A).

The LMF 190 has previously received the TOA estimates (see signaling 665, which for head UE Z is illustrated as TOA(Z)) for the head UEs 70 from the detectable gNBs and has computed the locations of the head UEs by means of classical UL TDOA. The computation of the locations of the head UEs is illustrated in FIG. 6 by the UL TDOA estimation for location (Z) in block 670. See also step 8.a of FIG. 5A.

The LMF 190 further uses the RTT(s) between the head UE 70 and group UE(s) 80, together with the locations obtained in the information from signaling 680 to compute the group UEs location in relation to the heads. This is illustrated in FIG. 6 as the RTT-group-UE estimation using head Z as TRP, which determines location (X) in block 685.

Note that once the locations of the head and group UEs, the network would proceed to use that information. Such use has been previously described in part and is also known.

Alternative embodiments include the following examples.

In an alternative embodiment, the UEs in the group may be served by different gNBs. In this case, the group of UEs may be generated by cooperation between gNBs, e.g., over an Xn interface, using the same/similar grouping criteria as outlined above.

In another embodiment, the L-SRS power may be controlled by the network, so that it is ensured that any L-SRS reaches the boundaries of the group's geographical coverage. This option may, for example, be used as fall back if a group UE L-SRS is not received by the head UE. The head UE will report the L-SRS reception failure to the serving gNB, or simply omit the reporting for that group UE, and consequently, for subsequent reporting, increased L-SRS power is requested for that group UE by the serving gNB.

Without in any way limiting the scope, interpretation, or application of the claims appearing below, a technical effect and advantage of one or more of the example embodiments disclosed herein is power saving of group UEs (no LPP connection with LMF required). Another technical effect and advantage of one or more of the example embodiments disclosed herein is the embodiments provide extended positioning coverage.

As used in this application, the term “circuitry” may refer to one or more or all of the following:

(a) hardware-only circuit implementations (such as implementations in only analog and/or digital circuitry) and

(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
3GPP third generation partnership project
5G fifth generation
5GC 5G core network
AMF access and mobility management function
BF beamforming
CM control module
CU central unit
DL PRS Downlink Positioning Reference Signal
DU distributed unit
eMBB enhanced mobile broadband
eMTC enhanced machine-type communication
eNB (or eNodeB) evolved Node B (e.g., an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
I/F interface
IoT Internet of things
KPI key performance indicator
LCS Location Service
LPP LTE Positioning Protocol
LMF location
LTE long term evolution
MAC medium access control
MME mobility management entity
NB narrowband
ng or NG next generation
ng-eNB or NG-eNB next generation eNB
NR new radio
NRPPa New Radio Positioning Protocol A
N/W or NW network
PDCP packet data convergence protocol
PHY physical layer
RAN radio access network
Rel release
RLC radio link control
RS reference signal
RRH remote radio head
RRC radio resource control
RSRP Reference Signal Received Power
RTOA Relative Time of Arrival
SINR Signal to Interference plus Noise Ratio
SRS sounding reference signals
SRS-P SRS for positioning
RSSI Received Signal Strength Indicator
RTOA relative time of arrival
RTT round trip time
RU radio unit
Rx receiver
SDAP service data adaptation protocol
SGW serving gateway
SMF session management function
SRS Sounding Reference Signals
TA Timing Advance
TDOA time difference of arrival
TOA time of arrival
TRP transmission reception point
TS technical specification
Tx transmitter
UE user equipment (e.g., a wireless, typically mobile device)
UL uplink
UPF user plane function
URLLC ultra-reliable, low-latency communication

1.-17. (canceled)

18. An apparatus, comprising:
at least one processor; and
at least one memory including computer program code,
the at least one memory and the computer program code configured, with the at least one processor, to cause the apparatus to perform operations comprising:
clustering by a transmission-reception point multiple user equipment into a group of user equipment;
configuring by the transmission-reception point selected ones of the user equipment in the group to be head user equipment,
configuring by the transmission-reception point user equipment not selected as head user equipment to be group user equipment, wherein the group user equipment are configured to send signals or calculated information used for positioning of the group user equipment to head user equipment instead of to the transmission-reception point;
receiving, at the transmission-reception point and from the head user equipment, calculated information that was calculated by the head user equipment from the signals or calculated information used for positioning of the group user equipment; and
forwarding by the transmission-reception point the calculated information from the head user equipment toward a network node for position determination of the group user equipment.

19. The apparatus of claim 3, wherein:
the signals for positioning of the group user equipment to head user equipment are first signals;
the head user equipment are configured to send to the transmission-reception point second signals used for positioning of the head user equipment and the group user equipment;
the at least one memory and the computer program code are further configured, with the at least one processor, to cause the apparatus to perform operations comprising:
determining time of arrival information for the head user equipment based on the second signals; and
sending by the transmission-reception point the time of arrival information toward the network node for position determination of the head user equipment.

20. The apparatus of claim 19, wherein the second signals used for positioning of the head user equipment comprise sounding reference signals from the head user equipment, and determining time of arrival information for the head user equipment further comprises determining the time of arrival information for the head user equipment based on the sounding reference signals.

21. The apparatus of claim 18, wherein the calculated information comprises round trip time determined by the head user equipment from the information for positioning of the group user equipment.

22. The apparatus of claim 18, wherein the at least one memory and the computer program code are further configured, with the at least one processor, to cause the apparatus to perform operations comprising: selecting by the transmission-reception point the head user equipment via one or more of the following:
1) in a round robin fashion;
2) based on the battery information for the user equipment;
3) by reported link quality for the user equipment;
4) by user equipment information; or
5) to minimize the geometric dilution of precision errors.

23. The apparatus of claim 22, wherein the selecting is performed in a manner proportional to any of (2) to (4).

24. The apparatus of claim 18, wherein configuring by the transmission-reception point selected ones of the user equipment in the group to be head user equipment further comprises configuring the head user equipment to send fixed sounding reference signals of a determined high power intended to reach the transmission-reception point and other transmission-reception points.

25. The apparatus of claim 18, wherein configuring by the transmission-reception point user equipment not selected as head user equipment to be group user equipment further comprises configuring the group user equipment to send sounding reference signals of a lower power than the high power, the lower power intended to reach all user equipment in the group.

26. The apparatus of claim 18, wherein certain group user equipment are configured to send the information for positioning of the group user equipment only to a selected one of the head user equipment.

27. The apparatus of claim 18, wherein the clustering of the user equipment into the group is based on one or both of similar signal strength measurements or timing advance measurements.

28. An apparatus, comprising:
at least one processor; and
at least one memory including computer program code,
the at least one memory and the computer program code configured, with the at least one processor, to cause the apparatus to perform operations comprising:
receiving, at a user equipment and from a transmission-reception point, configuration indicating the user equipment is to be a head user equipment, indicating that group user equipment are to send signals used for positioning of the group user equipment to corresponding head user equipment;
transmitting by the head user equipment first sounding reference signals toward the transmission-reception point and the group user equipment;
receiving, by the head user equipment and from one of the group user equipment,
second sounding reference signals for positioning of the one group user equipment;
calculating by the head user equipment information for positioning of the one group user equipment, the calculating based at least on the sending the first sounding reference signals and the receiving the sounding reference signals; and
sending by the head user equipment the calculated information toward the transmission-reception point for forwarding to a network node for position determination of the group user equipment.

29. The apparatus of claim 6, wherein:
the calculated information is first calculated information;
receiving, by the head user equipment and via one or more of the signals from the one group user equipment, second calculated information used for positioning of the one group user equipment;
calculating by the head user equipment the first calculated information further uses the second calculated information for positioning of the one group user equipment.

30. The apparatus of claim 28, wherein the at least one memory and the computer program code are further configured, with the at least one processor, to cause the apparatus to perform operations comprising: receiving, by the head user equipment and from the transmission-reception point, configuration to be used by the head user equipment for transmission of the first sounding reference signals.

31. The apparatus of claim 30, wherein receiving configuration to be used by the head user equipment for transmission of the first sounding reference signals further comprises receiving configuration for the head user equipment to transmit the first sounding reference signals of a determined high power intended to reach the transmission-reception point and other transmission-reception points and the transmitting the first sounding reference signals further comprises transmitting the first sounding reference signals at the determined high power.

32. The apparatus of claim 28, wherein:
the second calculated information comprises a value of computation performed by the one group user equipment of a transmission-reception time with respect to the head user equipment; and
calculating by the head user equipment first calculated information comprises calculating round trip time based on a time the first sounding reference signals were transmitted by the head user equipment, the time the second sounding reference signals were received by the head user equipment, and the transmission-reception time with respect to the head user equipment.

33. An apparatus, comprising:
at least one processor; and
at least one memory including computer program code,
the at least one memory and the computer program code configured, with the at least one processor, to cause the apparatus to perform operations comprising:
receiving, at a user equipment and from a transmission-reception point, configuration indicating the user equipment is to be a group user equipment, the config indicating that the group user equipment is to transmit signals for positioning of the group user equipment to corresponding head user equipment instead of to the transmission-reception point; and
transmitting, by the group user equipment and to the head user equipment, signals for positioning of the group user equipment.

34. The apparatus of claim 33, wherein:
the at least one memory and the computer program code are further configured, with the at least one processor, to cause the apparatus to perform operations comprising: comprises receiving by the group user equipment first sounding reference signals from the head user equipment;
the transmitting signals for positioning of the group user equipment further comprises transmitting by the group user equipment second sounding reference signals toward the head user equipment;
the at least one memory and the computer program code are further configured, with the at least one processor, to cause the apparatus to perform operations comprising: computing by the group user equipment transmission-reception time with respect to the head user equipment, the computing based on a time the first sounding reference signals, transmitted by the head user equipment, where received and based on a time the second sounding reference signals were transmitted toward the head user equipment; and
the transmitting signals for positioning of the group user equipment further comprises transmitting an indication of a value of the computed transmission-reception time with respect to the head user equipment.
